(19) United States
(12) Patent Application Publication
(10) Pub. No.: US 2010/0060612 A1
(43) Pub. Date: Mar. 11, 2010

(54) OPTO-TOUCH SCREEN

(75) Inventors: Sang Youl JEON, Suwon (KR); Il Kweon Joung, Seongnam (KR); Seung Heon Han, Seoul (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 12/391,716

(22) Filed: Feb. 24, 2009

(30) Foreign Application Priority Data
Sep. 9, 2008 (KR) 10-2008-0088773

(51) Int. Cl. G06F 3/042

(52) U.S. Cl. 345/175

(57) ABSTRACT

There is provided an opto-touch screen including: an opto-touch panel including an infrared phosphor material emitting light when exposed to infrared light; a sensor part disposed at a side of the opto-touch panel to detect the light emitted from the opto-touch panel.

### CROSS-REFERENCE TO RELATED APPLICATIONS

This application claims the priority of Korean Patent Application No. 2008-88773 filed on Sep. 9, 2008, in the Korean Intellectual Property Office, the disclosure of which is incorporated herein by reference.

### BACKGROUND OF THE INVENTION

1. Field of the Invention

The present invention relates to an opto-touch screen, and more particularly, to an opto-touch screen employing an infrared emission material emitting light in infrared ray spectrum to be touched by an infrared ray without physical contact.

2. Description of the Related Art

Recently, with dramatic development of software and semiconductor technology, and data processing technology, various data devices such as a mobile phone and a personal digital assistant (PDA), are increasingly multi-functional. Also, in the data devices, data storing through the input of data and communication are gaining more importance.

Conventionally, in inputting data in the data devices, an input key has been pressed. But, of late, data is increasingly input by utilizing a touch screen in the data devices.

In general, a touch screen is an input device replacing an input key, a key board and a mouse. The touch screen is installed on a screen and then directly touched through a hand or stylus pen to input data. The touch screen enables intuitive performance in a graphic user interface (GUI) environment and thus is suitable in a portable input device. Furthermore, the touch screen can be widely used in computer simulation applications, office automation applications, educational applications and game applications.

The input device using this touch screen basically includes a touch panel attached to a monitor, a controller, a device driver and an application program. The touch panel is formed of multi layers including a specially-treated ITO glass and ITO film so as to sense a signal inputted by a user. When a surface of the touch panel is touched by a hand or stylus pen, a location recognition sensor of a display senses a touched location on the touch panel.

In the touch screen using this touch panel, a hand or stylus pen should be touched directly on the touch panel, thus leaving a fingerprint on the surface of the touch panel or causing a scratch. Moreover, the touch screen, when applied to a large-scale display, cannot be operated from a remote distance.

### SUMMARY OF THE INVENTION

An aspect of the present invention provides an opto-touch screen capable of performing opto-touch from a remote distance without physical contact.

According to an aspect of the present invention, there is provided an opto-touch screen including: an opto-touch panel including an infrared phosphor material emitting light when exposed to infrared light; a sensor part disposed at a side of the opto-touch panel to detect the light emitted from the opto-touch panel.

The opto-touch screen may further include an estimator estimating a light emitting location on the opto-touch panel in response to a signal detected by the sensor part.

The infrared phosphor material may emit a visible light or an infrared light when exposed to infrared light.

The infrared phosphor material may react to light having a wavelength of about 900 nm and emit light having a wavelength of about 800 nm.

The opto-touch panel may include a sheet having the infrared phosphor material and a transparent material blended together.

The opto-touch panel may include: a transparent sheet; and an infrared phosphor sheet disposed on the transparent sheet. The opto-touch panel may further include another transparent sheet disposed on the infrared phosphor sheet.

The transparent sheet may include one of glass and acryl.

The sensor part may include at least two sensors provided such that the light emitting location is triangulated.

The sensor part may include an image sensor having a plurality of pixels arranged linearly, the plurality of pixels detecting the emitted light.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration view illustrating an opto-touch screen according to an exemplary embodiment of the invention;

FIGS. 2A to 2C are cross-sectional views illustrating various examples of an opto-touch panel employed in an opto-touch screen; and

FIG. 3 is a configuration view illustrating a television employing an opto-touch screen according to an exemplary embodiment of the invention.

### DETAILED DESCRIPTION OF THE PREFERRED EMBODIMENT

Exemplary embodiments of the present invention will now be described in detail with reference to the accompanying drawings.

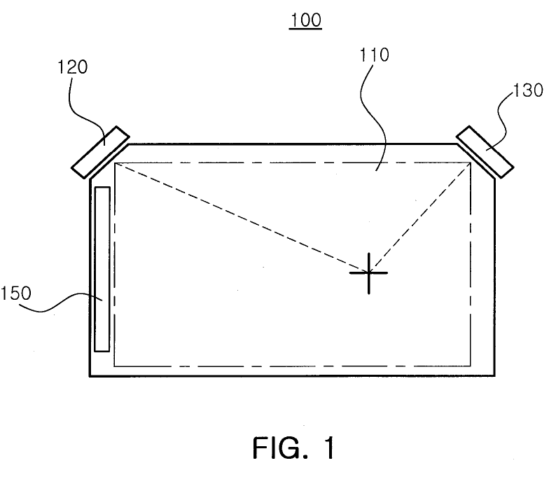

FIG. 1 is a configuration view illustrating an opto-touch screen according to an exemplary embodiment of the invention.

Referring to FIG. 1, the opto-touch screen 100 of the present embodiment includes an opto-touch panel 110, a sensor part, and an estimator part 150.

The opto-touch panel 110 may include an infrared phosphor material capable of emitting light when exposed to infrared light. The infrared phosphor material, when exposed to infrared light, can emit an infrared light or a visible light. In the present embodiment, the infrared phosphor material may utilize a phosphor material emitting light having a wavelength of about 850 nm when exposed to light of a wavelength of about 900 nm.

To form the opto-touch panel 110, the infrared phosphor material may be mixed with a transparent material such as glass and acryl.

The sensor part is formed at a side of the opto-touch panel 110 to detect a light emitting location on the opto-touch panel 110. In the present embodiment, the sensor part includes two sensors 120 and 130.

The sensors 120 and 130 each may include a pixel capable of detecting emitted light. By virtue of the light detected from the pixel, information on angles with respect to the light emitting location on the opto-touch panel can be obtained. Each of the sensors may have a plurality of pixels arranged linearly.

In the present embodiment, the sensor part includes the two sensors 120 and 130 disposed at corners of the opto-touch panel. In a case where the two sensors are employed as in the present embodiment, the light emitting location can be detected on the opto-touch panel 110 through triangulation, thereby ensuring the light emitting location is detected more accurately.

In the present embodiment, the sensors 120 and 130 each may have a pixel detecting an infrared ray or a pixel detecting a visible light.

The sensors may employ an image sensor having a plurality of pixels arranged therein, such as a complementary metal oxide semiconductor (CMOS) and a charge coupled device (CCD). The light emitted from the light emitting location can be detected from a pixel in a specific location.

The estimator part 150 is connected to the sensor part and estimates coordinates of the light emitting location based on the information on the light emitting location detected by the sensors 120 and 130. The estimator part 150 estimates coordinates of the light emitting location on the opto-touch panel 110 by using a delayed time required for the light detected from the sensors 120 and 130 to reach the sensor part, a size of a detected image, and a delay in phase.

The estimator part 150 can estimate the coordinates of the light emitting location by various methods. The estimator part 150 is connected to a central processor of an application where the opto-touch screen is employed and transfers an operation status of the opto-touch screen to the application.

Hereinafter, the operation of the opto-touch screen 100 will be described.

The opto-touch panel 110 may be attached to a display device such as a television (TV). The display device may be connected to an application program where a touch area for forming the touch screen is indicated.

The touch area can be displayed on the display device by the application program. When an infrared ray is irradiated onto the touch area indicated on the display using a pointer from the outside, the infrared ray can be irradiated onto an area of the touch panel 110 corresponding to the touch area indicated on the display. An infrared phosphor material distributed in the one area of the touch panel 110 where the infrared ray is irradiated emits light. Here, the emitted light has a wavelength varied according to type of the infrared phosphor material. In the present embodiment, the infrared phosphor material may adopt a phosphor material which reacts to light of a wavelength of about 900 nm and emits light of a wavelength of about 800 nm.

When light is emitted from the area of the opto-touch panel 110 where the infrared ray is irradiated, the emitted light propagates to a side portion of the opto-toch panel through the opto-touch panel. The opto-touch panel can serve as a waveguide of the emitted light. The sensors 120 and 130 of the sensor part disposed at the sides of the opto-touch panel 110 receive the emitted light.

The estimator part 150 estimates a location of the light emitting area by a wavelength and incident angle of the light received by the sensors 120 and 130. When the light emitting location in the opto-touch panel is estimated, the central processor of the display device connected to a controller 150 recognizes that the touch area indicated on the display corresponding to the light emitting location of the opto-touch panel is touched. Then, the next process follows.

In the present embodiment, the opto-touch screen is attached to the display device but an infrared ray is used without physical contact. This prevents scratches from occurring unnecessarily on a surface of the display device. Also, a touch screen performs functions conveniently from a remote distance.

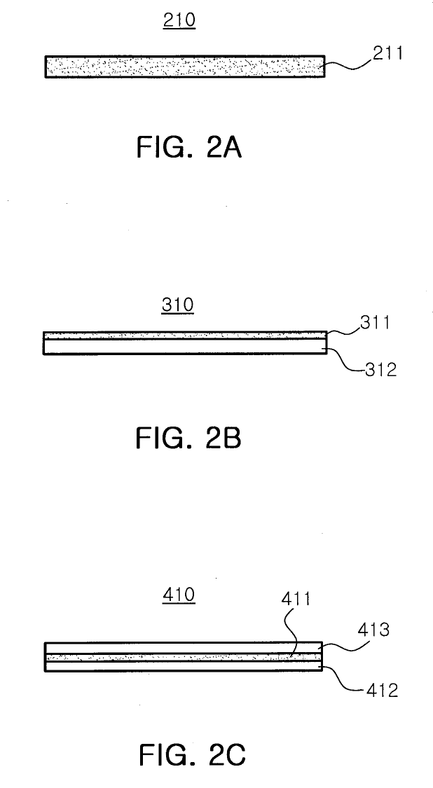

FIGS. 2A to 2C are cross-sectional views illustrating various examples of an opto-touch panel employed in an opto-touch screen.

Referring to FIG. 2A, an opto-touch panel 210 of the present embodiment may be configured as a sheet 211 having an infrared phosphor material and a transparent material blended together.

The transparent material may include glass or acryl. In the present embodiment, the infrared phosphor material and the transparent material are mixed at an adequate ratio to produce the opto-touch panel in the form of a sheet.

The infrared phosphor material contained in an opto-touch panel sheet 211 may emit an infrared light or a visible light when exposed to infrared light. With a greater amount of infrared phosphor material in the opto-touch panel sheet, the opto-touch panel can be delicately adjusted in sensitivity. A ratio between the infrared phosphor material and the transparent material may be varied according to use of a touch screen to be manufactured.

The transparent material transmits a visible light and the infrared phosphor material does not react to the visible light. Thus, even though the opto-touch panel sheet 211 is attached to the display device, a user can view the screen, without entailing the problem that the screen is obstructed by the opto-touch panel sheet.

Referring to FIG. 2B, the opto-touch panel 310 of the present embodiment may be configured such that an infrared phosphor material sheet 311 is disposed on a transparent sheet 312.

The transparent material for the transparent sheet 312 may include glass or acryl. In the present embodiment, the transparent sheet 312 may be formed of glass. The infrared phosphor material sheet 311 formed on the transparent sheet 312 may be a phosphor material emitting an infrared light or a visible light when exposed to infrared light.

In the opto-touch panel 310, with a greater amount of the infrared phosphor material in the infrared phosphor material sheet 311, the opto-touch panel can be delicately adjusted in sensitivity. A ratio of the infrared phosphor material in the infrared phosphor material sheet 311 can be varied according to use of a touch screen to be manufactured.

In the present embodiment, when the opto-touch panel 310 is installed on the display device, the infrared phosphor material sheet 311 may contact the display device and the transparent sheet 312 may be exposed outward. The transparent sheet 312 transmits a visible light but does not react to an infrared ray. Thus, the infrared ray can be incident on the infrared phosphor material sheet 311 through the transparent sheet 312 without any problem.

Referring to FIG. 2C, the opto-touch panel 410 of the present embodiment may be configured such that an infrared phosphor material sheet 411 is disposed between transparent sheets 412 and 413.

The transparent material for the transparent sheets 412 and 413 may include glass or acryl. In the present embodiment, the transparent sheets 412 and 413 may be formed of glass. The infrared phosphor material sheet 411 formed between the two transparent sheets 412 and 413 may be a phosphor material emitting an infrared ray or a visible light when exposed to infrared light.

In the opto-touch panel 410, with a greater amount of infrared phosphor material in the infrared phosphor material sheet 411, the opto-touch panel can be delicately adjusted in sensitivity. A ratio of the infrared phosphor material in the infrared phosphor material sheet 411 can be varied according to use of a touch screen to be manufactured.

In the present embodiment, when the opto-touch panel 410 is installed in the display device, the infrared phosphor material sheet 411 cannot be in contact with the display device nor exposed outward. In the opto-touch panel structured in this fashion, the infrared phosphor material sheet 411 as a main composition of the opto-touch panel can be protected to thereby lengthen a lifespan of the opto-touch panel 410.

The transparent sheets 412 and 413 transmit a visible light and do not react to an infrared ray. Thus, the infrared ray can be incident on the infrared phosphor material 411 through the transparent sheets 412 and 413 without any problem.

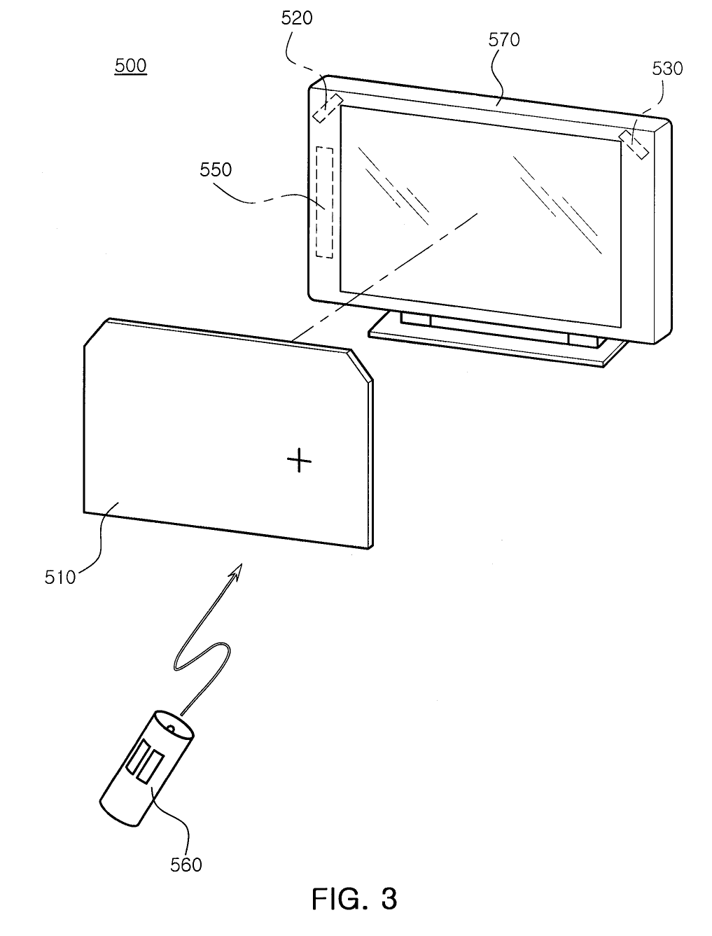

FIG. 3 is a configuration view illustrating a television employing an opto-touch screen according to an exemplary embodiment of the invention.

The television 500 of the present embodiment includes a television body 570, an opto-touch panel 510, a sensor part including two sensors 520 and 53, and an estimator part 550.

Recently, domestic televisions (TVs) enable viewers to watch selectively through interactive communication. Thus, users can select programs or search desired information through TVs at home. For this interactive communication, a touch screen method may be applied to the domestic televisions. When a conventional touch screen method is applied to the domestic televisions, a monitor should be directly touched using a hand or a pen. This may leave fingerprints or cause scratches on a TV screen. Also, users generally watch the television at a certain distance from the television monitor, and thus in order to directly touch the television monitor, are required to move frequently.

In the television 500 employing the opto-touch screen of the present embodiment, the opto-touch panel 510 can be mounted on a monitor of the television body, and the sensor part including the sensors 520 and 530 and the estimator part 550 can be embedded in the television body 570.

In the television 500 employing the opto-touch screen of the present embodiment, the opto-touch panel 510 mounted on the monitor of the television can be touched using an infrared ray pointer 560. The infrared ray pointer 560 emits an infrared ray. The infrared ray cannot be noticed by eyes and thus for convenience of the user, the infrared ray pointer 560 may be manufactured to emit both the infrared light and the visible light. That is, when the pointer 560 is configured to emit both the infrared light and the visible light to an identical location, the user can estimate a pointing position of the infrared light which is invisible to the eyes by virtue of a pointing location of the visible light which is visible to the eyes.

The opto-touch panel 510 where the infrared light is incident may include an infrared phosphor material emitting the infrared light. The infrared phosphor material may emit the infrared light or the visible light by the infrared ray.

The sensors 520 and 530 disposed at sides of the opto-touch panel 510 detect light emitted from the opto-touch panel 510. The sensors 520 and 530 each may contain a pixel capable of detecting emitted light. From the light detected from the pixel, angle information on a light emitting location on the opto-touch panel can be obtained. Each of the sensors may have a plurality of pixels arranged linearly.

The estimator part 550 can estimate a light emitting location on the opto-touch panel 510 using the light detected from the sensors 520 and 530. Information on the light emitting location estimated by the estimator part is transferred to a central processor operating the monitor of the television. Then, based on the information, it is determined whether a touch area outputted from the monitor of the television is touched to perform a following process.

As described above, in a television employing the opto-touch screen, the monitor of the television is free from unnecessary fingerprints or scratches. Also, the touch screen method can be utilized even from a remote distance to thereby ensure user-friendliness.

As set forth above, according to exemplary embodiments of the invention, an opto-touch screen enables opto-touch by an infrared ray even from a remote distance without a physical touch.

While the present invention has been shown and described in connection with the exemplary embodiments, it will be apparent to those skilled in the art that modifications and variations can be made without departing from the spirit and scope of the invention as defined by the appended claims.

What is claimed is:

1. An opto-touch screen comprising:
an opto-touch panel including an infrared phosphor material emitting light when exposed to infrared light;
a sensor part disposed at a side of the opto-touch panel to detect the light emitted from the opto-touch panel.

2. The opto-touch screen of claim 1, further comprising an estimator estimating a light emitting location on the opto-touch panel in response to a signal detected by the sensor part.

3. The opto-touch screen of claim 1, wherein the infrared phosphor material emits a visible light or an infrared light when exposed to infrared light.

4. The opto-touch screen of claim 1, wherein the infrared phosphor material reacts to light having a wavelength of about 900 nm and emits light having a wavelength of about 800 nm.

5. The opto-touch screen of claim 1, wherein the opto-touch panel comprises a sheet having the infrared phosphor material and a transparent material blended together.

6. The opto-touch screen of claim 1, wherein the opto-touch panel comprises:
a transparent sheet; and
an infrared phosphor sheet disposed on the transparent sheet.

7. The opto-touch screen of claim 6, wherein the opto-touch panel further comprises another transparent sheet disposed on the infrared phosphor sheet.

8. The opto-touch screen of claim 5, wherein the transparent sheet comprises one of glass and acryl.

9. The opto-touch screen of claim 1, wherein the sensor part comprises at least two sensors provided such that the light emitting location is triangulated.

10. The opto-touch screen of claim 1, wherein the sensor part comprises an image sensor having a plurality of pixels arranged linearly, the plurality of pixels detecting the emitted light.
